(19) United States
(12) Patent Application Publication
(10) Pub. No.: US 2026/0065510 A1
(43) Pub. Date: Mar. 5, 2026

(54) METHOD FOR PARAMETER OPTIMIZATION BETWEEN MULTIPLE CAMERAS USING LIDAR, AND COMPUTER PROGRAM RECORDED ON RECORD-MEDIUM TO EXECUTE THE SAME

(71) Applicant: MOBILTECH, Seoul (KR)

(72) Inventors: Jae Seung KIM, Seoul (KR); Gil Hyeon GIM, Seongnam-si (KR); Sang Hun HAN, Seongnam-si (KR); Hyeon Woo JEONG, Seoul (KR)

(73) Assignee: MOBILTECH, Seoul (KR)

(21) Appl. No.: 19/292,520

(22) Filed: Aug. 6, 2025

(30) Foreign Application Priority Data
Sep. 3, 2024 (KR) 10-2024-0119049

(51) Int. Cl. G06T 7/80; G01S 17/89

(52) U.S. Cl. CPC G06T 7/80; G01S 17/89; G06T 2207/10028; G06T 2207/30244; G06T 2207/30252

(57) ABSTRACT

The present invention proposes a method for optimizing parameters among multiple cameras using the coordinates of point cloud data obtained from a LiDAR. The method may include: receiving images captured by a plurality of cameras and, simultaneously, first point cloud data obtained from the LiDAR corresponding to the images; estimating parameters between the pre-stored map and the LiDAR by mapping the first point cloud data to second point cloud data included in a pre-stored map; estimating image coordinates corresponding to coordinates of at least one of the first and second point cloud data based on the estimated parameters by projecting at least one of the first and second point cloud data onto the plurality of images; and optimizing the parameters among the plurality of cameras based on an error between the estimated image coordinates and predefined target coordinates on the image corresponding to the estimated image coordinates.

### CROSS-REFERENCE TO RELATED APPLICATIONS AND CLAIM OF PRIORITY

This application claims the benefit of Korean Patent Application No. 10-2024-0119049, filed on Sep. 3, 2024, in the Korean Intellectual Property Office, the disclosure of which is incorporated herein in its entirety by reference.

### TECHNICAL FIELD

The present disclosure relates to parameter optimization. More specifically, the present disclosure relates to a method for optimizing parameters among multiple cameras using LiDAR, based on coordinates of point cloud data acquired from a LiDAR sensor, and a computer program recorded on a non-transitory storage medium for executing the same.

### BACKGROUND

Simultaneous Localization and Mapping (SLAM) is an algorithm capable of performing localization and mapping concurrently.

Simultaneous Localization and Mapping (SLAM) can be classified into various types depending on the type of data used as the basis for localization and mapping. These include Visual SLAM (VSLAM), Monocular VSLAM, Stereo Camera VSLAM, RGB-D VSLAM, LIDAR SLAM, and RADAR SLAM. In addition, SLAM can also be categorized according to the type of implementation algorithm, such as Extended Kalman Filter SLAM (EKF SLAM), Feature from Accelerated Segment Test SLAM (FAST SLAM), Graph-based SLAM, Oriented FAST and Rotated BRIEF SLAM (ORB SLAM), Large-Scale Direct Monocular SLAM (LSD SLAM), and Visual Odometry with Deep Recurrent Convolutional Neural Networks (DeepVO).

Such SLAM techniques can be implemented based on data acquired from various sensors including Light Detection and Ranging (LiDAR), cameras, Inertial Measurement Units (IMUs), and other types of sensors. These techniques are utilized in a wide range of tasks, including path planning, path following, object tracking, and sensor fusion.

However, the various sensors used to acquire, capture, or measure data for SLAM cannot be physically installed at a perfectly identical single point. Therefore, in order to perform SLAM based on data acquired, captured, or measured by different sensors, it is essential to first perform calibration of the acquired data and optimization of the estimated parameters.

### SUMMARY

The present disclosure proposes a method for optimizing parameters among multiple cameras using coordinates of point cloud data acquired from a LiDAR sensor. The method may include: receiving, by a map generation device, a plurality of images captured from a plurality of cameras and first point cloud data acquired from a LiDAR sensor simultaneously with the plurality of images; estimating, by the map generation device, parameters between the pre-stored map and the LiDAR by mapping the first point cloud data to second point cloud data included in the pre-stored map; projecting, by the map generation device, at least one of the first point cloud data and the second point cloud data onto the plurality of images, and estimating, based on the estimated parameters, image coordinates corresponding to the coordinates of at least one of the first point cloud data and the second point cloud data; and optimizing, by the map generation device, parameters among the plurality of cameras based on an error between the estimated image coordinates and preset target coordinates on the images corresponding to the estimated image coordinates.

The first point cloud data and the second point cloud data may include point cloud data acquired from a calibration board, and the plurality of cameras may capture at least a portion of the calibration board.

The step of estimating the coordinates may include estimating, based on at least one corner point of the calibration board included in at least one of the first point cloud data and the second point cloud data, image coordinates on the images captured from the plurality of cameras corresponding to the corner point.

The step of estimating the coordinates may include: projecting the second point cloud data onto an image captured from a first camera to estimate the image coordinates on the image captured from the first camera corresponding to the coordinates of the second point cloud data; and projecting the second point cloud data onto at least one image captured from a (n+1)-th camera, and estimating, based on the parameters obtained in the process of estimating the image coordinates on the image captured from the first camera and the parameters between the pre-stored map and the LiDAR, image coordinates on the at least one image captured from the (n+1)-th camera corresponding to the coordinates of the first point cloud data.

The step of estimating the image coordinates on the image captured from the first camera may include estimating the image coordinates corresponding to the coordinates of the first point cloud data on the image captured from the first camera through the following Equation 1:

$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation 1 ]$$

Here, X, Y, and Z denote the three-dimensional coordinates of the second point cloud data; x_{C1} and y_{C1} denote the two-dimensional coordinates of the first camera corresponding to the three-dimensional coordinates of the second point cloud data; K₁ and D₁ denote the intrinsic parameters of the first camera; and RT₁ denotes the extrinsic parameters between the pre-stored map and the first camera.

D₁ is characterized by being calculated according to the following Equation 2:

$$r ( x ) = {k}_{4} * {x}^{9} + {k}_{3} * {x}^{7} + {k}_{2} * {x}^{5} + {k}_{1} * {x}^{3} + x \qquad [ Equation 2 ]$$

k₄, k₃, k₂, and k₁ denote distortion coefficients, and x may represent an incident angle of an arbitrary three-dimensional point projected onto the image during the parameter search process, with respect to the optical axis.

The step of estimating the image coordinates on at least one image captured from the (n+1)-th camera includes estimating the image coordinates on at least one image captured from the (n+1)-th camera corresponding to the coordinates of the first point cloud data through the following Equation 3:

$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] [ {RT}_{LiDAR} ] * [ \begin{matrix}X \\ Y \\ Z \\ 1\end{matrix} ] \qquad [ Equation 3 ]$$

Here, X, Y, and Z denote the three-dimensional coordinates of the first point cloud data; x_{Cn+1} and y_{Cn+1} denote the two-dimensional coordinates of the (n+1)-th camera corresponding to the three-dimensional coordinates of the first point cloud data; Kₙ₊₁ and Dₙ₊₁ denote the intrinsic parameters of the (n+1)-th camera; RTₙ₊₁ denotes the extrinsic parameters between the LiDAR and the (n+1)-th camera; and RT₁ denotes the extrinsic parameters between the pre-stored map and the first camera.

Dₙ₊₁ is characterized by being calculated according to the following Equation 4:

$$γ ( x ) = {k}_{4} * {x}^{9} + {k}_{3} * {x}^{7} + {k}_{2} * {x}^{5} + {k}_{1} * {x}^{3} + x \qquad [ Equation 4 ]$$

Here, k₄, k₃, k₂, and k₁ denote distortion coefficients, and x may represent an incident angle of an arbitrary three-dimensional point projected onto the image during the parameter search process, with respect to the optical axis.

The step of estimating the coordinates may include: projecting the second point cloud data onto an image captured from the first camera to estimate a first coordinate on the image captured from the first camera corresponding to the coordinates of the second point cloud data; projecting the second point cloud data onto at least one image captured from the (n+1)-th camera, and estimating, based on the parameters obtained in the process of estimating the coordinates on the image captured from the first camera, a second coordinate on the at least one image captured from the (n+1)-th camera corresponding to the coordinates of the second point cloud data; and projecting at least one image captured from the (n+1)-th camera onto the pre-stored map, and estimating, based on the parameters obtained in the process of estimating the coordinates on the image captured from the first camera and the parameters between the pre-stored map and the LiDAR, a third coordinate on the at least one image captured from the (n+1)-th camera corresponding to the coordinates of the second point cloud data.

The step of estimating the first coordinate may include estimating the coordinate on the image captured from the first camera corresponding to the coordinate of the second point cloud data through the following Equation 5.

$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation 5 ]$$

Here, X, Y, and Z denote the three-dimensional coordinates of the second point cloud data; x_{C1} and y_{C1} denote the two-dimensional coordinates of the first camera corresponding to the three-dimensional coordinates of the second point cloud data; K₁ and D₁ denote the intrinsic parameters of the first camera; and RT₁ denotes the extrinsic parameters between the pre-stored map and the first camera.

D₁ is characterized by being calculated according to the following Equation 6.

$$γ ( x ) = {k}_{4} * {x}^{9} + {k}_{3} * {x}^{7} + {k}_{2} * {x}^{5} + {k}_{1} * {x}^{3} + x \qquad [ Equation 6 ]$$

Here, k₄, k₃, k₂, and k₁ denote distortion coefficients, and x may represent an incident angle of an arbitrary three-dimensional point projected onto the image during the parameter search process, with respect to the optical axis.

The step of estimating the second coordinate includes estimating the second coordinate based on the following Equation 7.

$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] * [ \begin{matrix}X \\ Y \\ Z \\ 1\end{matrix} ] \qquad [ Equation 7 ]$$

Here, X, Y, and Z denote the three-dimensional coordinates of the second point cloud data; x_{Cn+1} and y_{Cn+1} denote the two-dimensional coordinates of the (n+1)-th camera corresponding to the three-dimensional coordinates of the second point cloud data; Kₙ₊₁ and Dₙ₊₁ denote the intrinsic parameters of the (n+1)-th camera; RTₙ₊₁ denotes the extrinsic parameters between the pre-stored map and the (n+1)-th camera; and RT₁ denotes the extrinsic parameters between the pre-stored map and the first camera.

Dₙ₊₁ is characterized by being calculated according to the following Equation 8.

$$γ ( x ) = {k}_{4} * {x}^{9} + {k}_{3} * {x}^{7} + {k}_{2} * {x}^{5} + {k}_{1} * {x}^{3} + x \qquad [ Equation 8 ]$$

Here, k₄, k₃, k₂, and k₁ denote distortion coefficients, and x may represent an incident angle of an arbitrary three-dimensional point projected onto the image during the parameter search process, with respect to the optical axis.

The step of estimating the third coordinate includes estimating the third coordinate based on the following Equation 9.

$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] [ {RT}_{LiDAR} ] * [ \begin{matrix}X \\ Y \\ Z \\ 1\end{matrix} ] \qquad [ Equation 9 ]$$

Here, X, Y, and Z denote the three-dimensional coordinates of the second point cloud data; x_{Cn+1} and y_{Cn+1} denote the two-dimensional coordinates of the (n+1)-th camera corresponding to the three-dimensional coordinates of the second point cloud data; Kₙ₊₁ and Dₙ₊₁ denote the intrinsic parameters of the (n+1)-th camera; RTₙ₊₁ denotes the extrinsic parameters between the pre-stored map and the (n+1)-th camera; RT₁ denotes the extrinsic parameters between the pre-stored map and the first camera; and RTLiDAR denotes the parameters between the pre-stored map and the LiDAR sensor.

Dₙ₊₁ is characterized by being calculated according to the following Equation 10.

$$γ ( x ) = {k}_{4} * {x}^{9} + {k}_{3} * {x}^{7} + {k}_{2} * {x}^{5} + {k}_{1} * {x}^{3} + x \qquad [ Equation 10 ]$$

Here, k₄, k₃, k₂, and k₁ denote distortion coefficients, and x may represent an incident angle of an arbitrary three-dimensional point projected onto the image during the parameter search process, with respect to the optical axis.

The step of optimizing the parameters is characterized by optimizing the parameters among the plurality of cameras using an error function defined by the following Equation 11.

$${f}^{n} = [ \begin{matrix}{x}_{dest}^{n} - {x}_{Cx}^{n} \\ {y}_{dest}^{n} - {y}_{Cx}^{n}\end{matrix} ] \qquad [ Equation 11 ]$$

$${x}_{dest}^{n} and {y}_{dest}^{n}$$

denote the target coordinates, and

$${x}_{Cx}^{n} and {y}_{Cx}^{n}$$

denote the estimated image coordinates corresponding to the target coordinates.

The step of optimizing the parameters is characterized by optimizing the parameters among the LiDAR and the pre-stored map, the pre-stored map and the first camera, and between the first camera and the n-th camera, based on the error function.

To achieve the above-described technical objectives, the present disclosure further provides a computer program recorded on a non-transitory storage medium for executing the method. The computer program may be combined with a computing device comprising a memory, a transceiver, and a processor configured to process instructions stored in the memory. The computer program may be configured to cause the processor to: receive a plurality of images captured from a plurality of cameras fixedly installed with respect to each other, and first point cloud data acquired from a LiDAR sensor simultaneously with the plurality of images; map the first point cloud data to second point cloud data included in a pre-stored map, and estimate parameters between the pre-stored map and the LiDAR; project at least one of the first point cloud data and the second point cloud data onto the plurality of images, and estimate, based on the estimated parameters, image coordinates corresponding to at least one of the coordinates of the first point cloud data and the second point cloud data; and optimize the parameters among the plurality of cameras based on an error between the estimated image coordinates and preset target coordinates corresponding to the estimated image coordinates on the image.

Further details of other embodiments are included in the following description and drawings.

### BRIEF DESCRIPTION OF THE DRAWINGS

FIG. 1 is a block diagram illustrating a configuration of a mapping system according to an embodiment of the present disclosure.

FIG. 2 is a logical block diagram illustrating a configuration of a map generation device according to an embodiment of the present disclosure.

FIGS. 3 and 4 are example diagrams illustrating a process of estimating parameters for a camera according to an embodiment of the present disclosure.

FIGS. 5 and 6 are example diagrams illustrating a process of optimizing parameters according to an embodiment of the present disclosure.

FIG. 7 is an example diagram illustrating a process of optimizing parameters according to another embodiment of the present disclosure.

FIG. 8 is an example diagram illustrating a process of optimizing parameters according to another embodiment of the present disclosure.

FIG. 9 is an example diagram illustrating a process of optimizing parameters according to yet another embodiment of the present disclosure.

FIG. 10 is a block diagram illustrating a hardware configuration of a map generation device according to an embodiment of the present disclosure.

FIG. 11 is a flowchart illustrating a method for optimizing parameters among multiple cameras using a map according to an embodiment of the present disclosure.

FIG. 12 is a flowchart illustrating a method for optimizing parameters among multiple cameras using LiDAR according to an embodiment of the present disclosure.

FIG. 13 is a flowchart illustrating a method for optimizing parameters between a LiDAR and a camera in consideration of image distortion according to an embodiment of the present disclosure.

### DETAILED DESCRIPTION

An object of the present disclosure is to provide a method for optimizing parameters among multiple cameras using coordinates of point cloud data acquired from a LiDAR sensor.

Another object of the present disclosure is to provide a computer program recorded on a non-transitory storage medium for executing the method of optimizing parameters among multiple cameras using coordinates of point cloud data acquired from a LiDAR sensor.

The technical problems addressed by the present disclosure are not limited to the aforementioned objectives, and other technical problems not explicitly stated will be clearly understood by those skilled in the art from the following description.

According to embodiments of the present disclosure, by optimizing parameters among a plurality of cameras such that the error between the image coordinates derived from LiDAR-based data and the target coordinates on the image is minimized, the accuracy of parameter estimation among the plurality of cameras can be improved.

The effects of the present disclosure are not limited to those mentioned above, and other effects not explicitly stated will be clearly understood by those of ordinary skill in the art from the descriptions set forth in the claims.

The technical terms used in this specification are merely intended to describe particular embodiments and are not to be construed as limiting the scope of the present disclosure. Unless otherwise defined, the technical terms used herein should be interpreted based on their meanings commonly understood by those skilled in the art to which the present disclosure pertains. These terms should not be interpreted in an overly broad or overly narrow sense. In addition, if any of the technical terms used herein are misused and fail to accurately reflect the intent of the present disclosure, such terms should be interpreted as being replaced by appropriate technical terms that would be correctly understood by those skilled in the art.

General terms used in this specification should be interpreted based on definitions provided in standard references or in the context in which they are used, and should not be interpreted in an unduly limited manner.

Singular expressions used herein shall be understood to include the plural unless the context clearly indicates otherwise. In the present application, terms such as “comprise” or “have” should not be interpreted as requiring all components or steps recited herein to be included. Rather, such terms should be interpreted as allowing for the inclusion of some components or steps, or the inclusion of additional components or steps.

Furthermore, ordinal terms such as “first” and “second” used in this specification may be used to describe various components but do not imply any limitation of the components. These terms are only used to distinguish one component from another. For example, a “first” component may be referred to as a “second” component, and similarly, a “second” component may be referred to as a “first” component, without departing from the scope of the present disclosure.

When a component is described as being “connected to” or “coupled to” another component, it may be directly connected or coupled to that component, or it may be connected or coupled indirectly through another component. In contrast, when a component is described as being “directly connected to” or “directly coupled to” another component, it should be understood that no other component exists in between.

Hereinafter, preferred embodiments of the present disclosure will be described in detail with reference to the accompanying drawings. In the drawings, like reference numerals are used to designate like or similar elements, and redundant descriptions thereof may be omitted. In describing the present disclosure, detailed descriptions of related known technologies may be omitted when they are deemed to obscure the subject matter of the present disclosure.

The accompanying drawings are provided merely for ease of understanding the inventive concept of the present disclosure and should not be construed as limiting the scope of the present disclosure. The scope of the present disclosure should be interpreted as extending to all modifications, equivalents, and substitutes beyond the attached drawings.

As described above, various sensors used to acquire, capture, or measure data for mapping cannot be physically installed at a perfectly identical single point. Therefore, in order to perform mapping based on data acquired, captured, or measured by different sensors, it is essential to first perform calibration of the acquired data and optimization of the estimated parameters.

The present disclosure aims to propose various approaches that enable effective calibration of devices and data used for mapping.

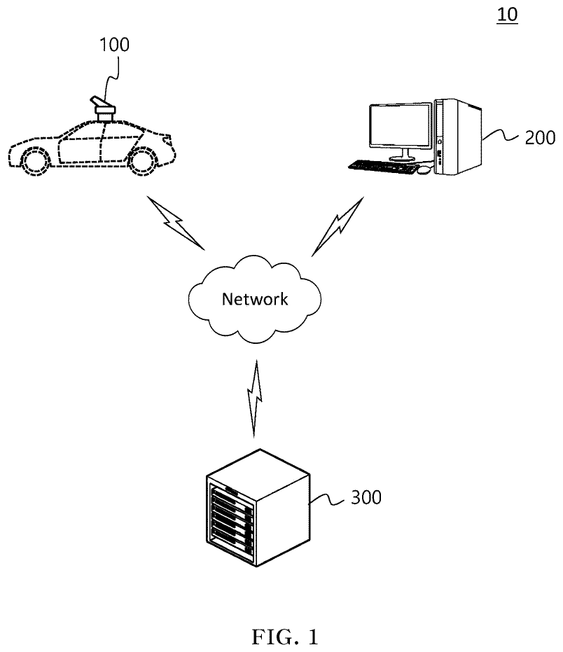

FIG. 1 is a block diagram illustrating a configuration of a mapping system according to an embodiment of the present disclosure.

Referring to FIG. 1, the mapping system 10 according to one embodiment of the present disclosure may include a data collection device 100, a map generation device 200, and a map application device 300.

The components of the mapping system 10 according to this embodiment are merely functionally distinguished elements. In a real-world environment, two or more components may be implemented as an integrated module, or one component may be physically separated into multiple implementations.

Each component will now be described. The data collection device 100 may be mounted on a movable platform (mobility) and may collect data required for map generation. For example, the data collection device 100 may be mounted on a vehicle, airplane, or drone to collect the data necessary for mapping.

To this end, the data collection device 100 may include one or more of a LiDAR, a camera, a radar, an inertial measurement unit (IMU), and a GPS. Additionally, the data collection device 100 may further include other sensors for acquiring various types of information required for high-precision map generation.

More specifically, the LiDAR of the data collection device 100 may emit laser pulses and detect the reflected light from surrounding objects to generate point cloud data, which corresponds to a three-dimensional representation of the surroundings.

The camera of the data collection device 100 may capture images of a space. The camera may be, for example, a color camera, a near-infrared (NIR) camera, a short-wavelength infrared (SWIR) camera, or a long-wavelength infrared (LWIR) camera, but is not limited thereto.

The inertial measurement unit (IMU) of the data collection device 100 may include an acceleration sensor and a gyroscope, and in some cases, may further include a magnetometer. The IMU may measure acceleration and angular velocity in response to the movement of the mobility on which the data collection device 100 is installed.

The GPS may generate location coordinates of the data collection device 100 by performing triangulation based on multiple signals received from satellites.

The data collection device 100 may transmit the collected data to at least one of the map generation device 200 and the map application device 300.

The map generation device 200 may generate a map using the data collected by the data collection device 100.

In particular, the map generation device 200 according to various embodiments of the present disclosure may calibrate point cloud data and images obtained or captured by the LiDAR and camera, or may estimate and optimize various parameters related to the cameras.

Although the calibration of point cloud data and images and the estimation and optimization of parameters are described separately in this specification, it will be readily apparent to those skilled in the art that these processes may be performed in parallel or in sequence.

The detailed configuration and operation of the map generation device 200 according to various embodiments of the present disclosure will be described later with reference to the drawings.

The map application device 300 may directly apply the map generated by the map generation device 200 to various application fields or may perform processing for such application.

For example, the map application device 300 may be a device that performs a location-based service (LBS) based on the map generated by the map generation device 200. Alternatively, the map application device 300 may add metadata to objects included in the map, or may detect objects within the map.

The map generation device 200 and the map application device 300 may be implemented using any device capable of transmitting and receiving data and performing computations based on the received data. For example, the map generation device 200 and the map application device 300 may be implemented as a desktop, workstation, or server, but are not limited thereto.

In addition, the data collection device 100, the map generation device 200, and the map application device 300 may transmit and receive data through a network composed of a secure direct connection, a public wired communication network, or a mobile communication network, or a combination thereof.

For example, the public wired communication network may include Ethernet, xDSL, hybrid fiber coaxial (HFC), or fiber to the home (FTTH), but is not limited thereto. The mobile communication network may include Code Division Multiple Access (CDMA), Wideband CDMA (WCDMA), High Speed Packet Access (HSPA), Long Term Evolution (LTE), or 5th/6th generation mobile communication, but is not limited thereto.

Hereinafter, the configuration of the map generation device 200 described above will be explained in more detail.

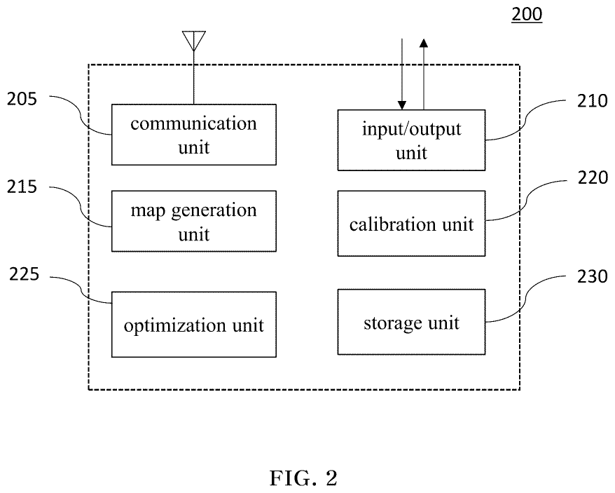

FIG. 2 is a logical block diagram illustrating a configuration of a map generation device according to an embodiment of the present disclosure.

Referring to FIG. 2, the map generation device 200 according to various embodiments of the present disclosure may include a communication unit 205, an input/output unit 210, a map generation unit 215, a calibration unit 220, an optimization unit 225, and a storage unit 230.

These components of the map generation device 200 are merely functionally distinguished elements. In a real-world implementation, two or more components may be integrated together, or a single component may be separated into multiple physical modules.

Each component is described as follows. The communication unit 205 may transmit and receive data to and from the data collection device 100 and the map application device 300.

Specifically, the communication unit 205 may receive data necessary for mapping from the data collection device 100. The data necessary for mapping may include one or more of point cloud data, images, acceleration and angular velocity data, and location coordinates, but is not limited thereto. The communication unit 205 may also transmit the generated map to the map application device 300.

The input/output unit 210 may receive user inputs through a user interface (UI) or output computation results externally.

The input/output unit 210 may output the mapping data received from the data collection device 100. It may receive various configuration values for calibrating point cloud data and images. It may also output calibrated point cloud data and images, as well as the estimated and optimized camera parameters.

The map generation unit 215 may generate a map based on the data collected by the data collection device 100.

Specifically, the map generation unit 215 may generate the map based on SLAM (Simultaneous Localization and Mapping) or Mobile Mapping System (MMS) technology.

In one embodiment, the map generation unit 215 generates a map based on SLAM. First, the map generation unit 215 may receive the collected data from the data collection device 100 via the communication unit 205. The map generation unit 215 may parse the point cloud data sequentially acquired by the LiDAR. The parsed point cloud data may then be registered. Based on the registered point cloud data, GNSS (Global Navigation Satellite System) data may be generated. By repeatedly parsing and registering point cloud data acquired over more than 10 seconds and generating GNSS data, the map generation unit 215 may perform SLAM.

The calibration unit 220 may perform calibration for at least one combination of the pre-stored map, the LiDAR, and the plurality of cameras.

For example, the calibration unit 220 may estimate extrinsic and intrinsic parameters between a camera and the LiDAR.

Here, extrinsic parameters may include a rotation matrix and translation matrix (RT) representing the position and orientation of the fixed camera on the mobility platform. Intrinsic parameters may include the focal length and optical center based on the camera's lens and sensor.

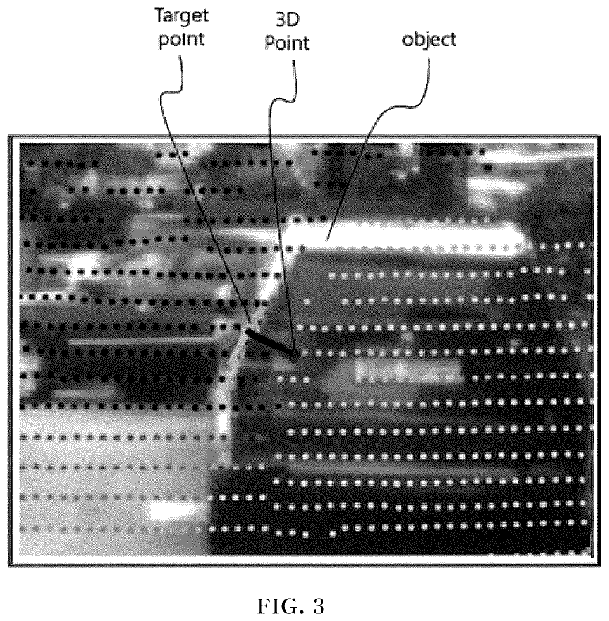

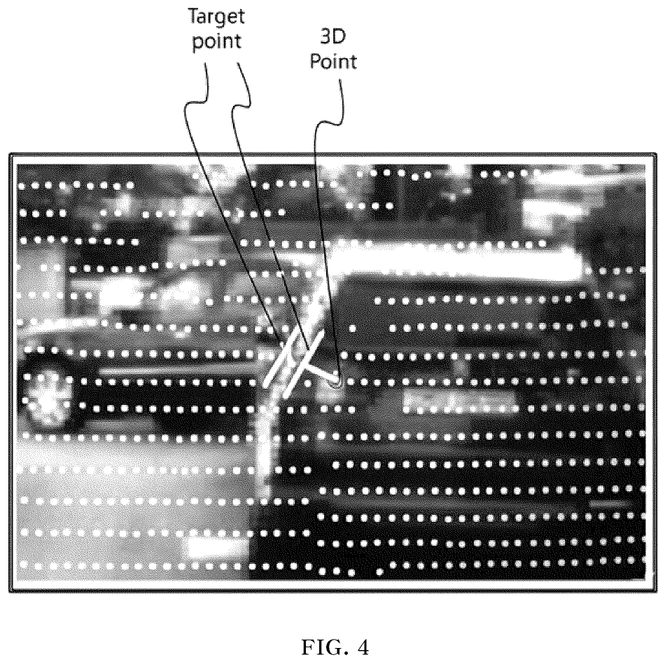

The calibration process performed by the calibration unit 220 is described with reference to FIGS. 3 and 4.

FIGS. 3 and 4 are example diagrams illustrating the process of estimating camera parameters according to an embodiment of the present disclosure.

The calibration unit 220 may project point cloud data acquired from the LiDAR onto images captured by a camera. The point cloud data may correspond to a pre-generated map from the map generation unit 215. This map may be generated based on point cloud data and images acquired and captured respectively by a LiDAR and a camera installed on the same platform.

As shown in FIG. 3, if the point cloud data projected onto the image does not align with object edges in the image, overlay mismatches may occur.

In one embodiment, the calibration unit 220 may project the point cloud data onto the image and select one of the 3D points projected onto the image. The selected 3D point may correspond to an edge of an object. Then, a corresponding target point on the image may be selected—e.g., a straight line on the image. The calibration unit 220 may estimate parameters such that the selected 3D point lies on the selected line.

In another embodiment shown in FIG. 4, the calibration unit 220 may select a target point as two lines instead of one. Then, it may estimate parameters such that the 3D point lies between the two lines.

In yet another embodiment, the calibration unit 220 may identify a first edge based on the depth of the selected 3D point. For example, it may extract other 3D points with the same depth and recognize the edge they form. Then, it may identify a second edge in the image corresponding to the first edge and estimate parameters such that the 3D point lies on that edge.

This process of selecting 3D points and target points may be performed manually or automatically.

Specifically, the calibration unit 220 may allow a user to input criteria via the input/output unit 210 to select the points.

Alternatively, the calibration unit 220 may perform feature detection on both the point cloud data and the image.

For example, SIFT, SURF, ORB, FAST, BRISK, or AKAZE may be used for feature detection.

By comparing feature descriptors of key points in the point cloud and the image (e.g., using brute-force matching or k-NN), the calibration unit 220 may determine corresponding 3D points and image points.

Then, the calibration unit 220 may estimate the camera's extrinsic parameters under the condition that the 3D point is projected onto the target point.

More specifically, the calibration unit 220 may construct a matrix to convert the world coordinates of a 3D point into camera coordinates of the target point.

Here, world coordinates refer to the object's position relative to a fixed origin in 3D space, while camera coordinates refer to the object's position relative to the camera center.

Using the constructed matrix, the calibration unit 220 may estimate the camera's extrinsic parameters.

For example, it may construct a transformation matrix to convert the world coordinates P(U, V, W) into camera coordinates (X, Y, Z) as follows:

$$[ \begin{matrix}X \\ Y \\ Z\end{matrix} ] = [ \begin{matrix}{r}_{00} & {r}_{01} & {r}_{02} & {t}_{x} \\ {r}_{10} & {r}_{11} & {r}_{12} & {t}_{y} \\ {r}_{20} & {r}_{21} & {r}_{22} & {t}_{z}\end{matrix} ] [ \begin{matrix}U \\ V \\ W \\ 1\end{matrix} ]$$

The calibration unit 220 may estimate the extrinsic parameters of the camera based on the rotation transformation values (r00, r01, r02, r10, r11, r12, r20, r21, r22) and the translation vector (tx, ty, tz) included in the constructed matrix.

When three pairs of 3D points and corresponding target points are selected from the point cloud data and the image, respectively, the calibration unit 220 may identify a single condition under which the three 3D points are each projected onto the corresponding target points. Based on this identified condition, the calibration unit 220 may estimate the extrinsic parameters of the camera.

If, under the identified condition, only two of the three 3D points are projected onto the corresponding target points while the third 3D point is not projected onto its target point, the calibration unit 220 may select a new 3D point and a new target point from the point cloud data and the image, and verify whether the new 3D point is projected onto the target point under the same identified condition.

Subsequently, the calibration unit 220 may estimate the intrinsic parameters of the camera based on the condition that the target point is projected onto the image plane.

More specifically, the calibration unit 220 may construct a matrix for converting the camera coordinates of the target point into image coordinates on the image. Here, the image coordinates represent the pixel location on the two-dimensional image. Based on the constructed matrix, the calibration unit 220 may estimate the intrinsic parameters.

For example, the calibration unit 220 may construct a matrix for converting the camera coordinates (X, Y, Z) of the target point into image coordinates (x, y) as follows:

$$[ \begin{matrix}x \\ y \\ 1\end{matrix} ] = s [ \begin{matrix}{f}_{x} & 0 & {c}_{x} \\ 0 & {f}_{y} & {c}_{y} \\ 0 & 0 & 1\end{matrix} ] [ \begin{matrix}X \\ Y \\ Z\end{matrix} ]$$

The calibration unit 220 may estimate the intrinsic parameters of the camera based on the focal lengths (fx, fy) and the optical center (cx, cy) included in the constructed matrix. Here, s in the constructed matrix denotes a scale factor.

The optimization unit 225 may optimize at least one of the extrinsic parameters and the intrinsic parameters obtained from the calibration unit 220.

To this end, the optimization unit 225 may optimize the intrinsic parameters using an algorithm related to non-linear least squares.

For example, the optimization unit 225 may use the Levenberg-Marquardt method, which is a well-known algorithm for non-linear least squares optimization, but is not limited thereto. The optimization unit 225 may alternatively or additionally use the Newton-Raphson method, Gauss-Newton method, gradient descent method, or any combination thereof.

Hereinafter, various embodiments for reducing error when optimizing at least one of the extrinsic and intrinsic parameters obtained from the calibration unit 220 using a non-linear least squares algorithm will be described.

Although each of the following embodiments is described separately, they may be applied individually or in combination.

In one embodiment, the optimization unit 225 may optimize parameters among a plurality of cameras that are fixedly installed on a vehicle using the coordinates of point cloud data from a calibration board included in a pre-stored map in a fixed environment.

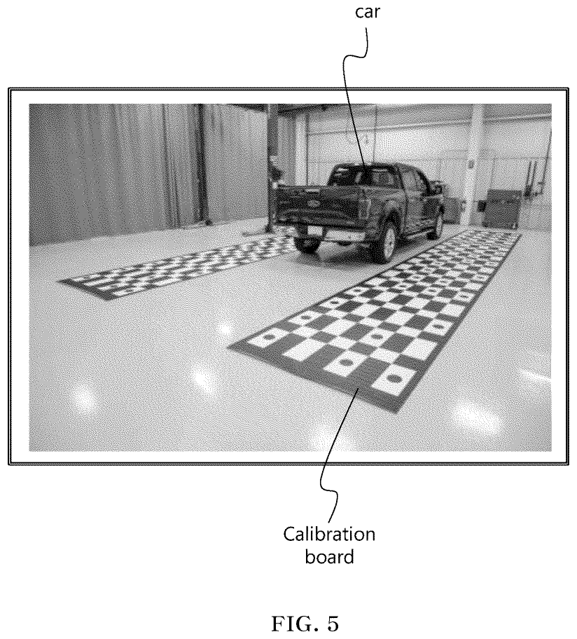

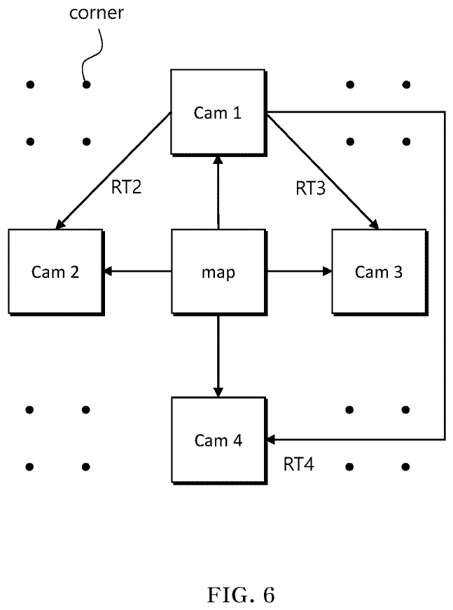

FIGS. 5 and 6 are example diagrams illustrating the parameter optimization process according to one embodiment of the present disclosure.

Specifically, FIG. 5 shows a sample image of the environment used for optimization in one embodiment.

As shown in FIG. 5, the optimization unit 225 may optimize the parameters among a plurality of cameras fixedly installed on a vehicle, based on a map including point cloud data of an environment in which a calibration board is placed on the ground.

As shown in FIG. 6, the optimization unit 225 may optimize the parameters of the plurality of cameras (cam1, cam2, cam3, and cam4) that are fixedly installed on the vehicle. Here, the pre-stored map may include point cloud data acquired from the calibration board. The plurality of cameras may capture at least a portion of the calibration board.

Although four cameras (cam1 through cam4) are used in this embodiment, the number of cameras is not limited to four and may vary.

The optimization unit 225 may estimate image coordinates of pixels corresponding to at least one corner point of the calibration board included in the point cloud data, by projecting the point cloud data onto images captured by the cameras.

More specifically, the optimization unit 225 may receive a plurality of images captured by the fixed cameras (cam1 to cam4), and project the point cloud data from the pre-stored map onto the images to estimate the image coordinates corresponding to the point cloud coordinates.

To do this, the optimization unit 225 may first project the point cloud data onto the image captured by the first camera (cam1), and estimate the image coordinates on the image of the first camera (cam1) corresponding to the point cloud data in the pre-stored map.

In other words, the optimization unit 225 may estimate the image coordinates on the image captured by the first camera (cam1) corresponding to the point cloud data in the pre-stored map using the following Equation:

$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation ]$$

Here, X, Y, and Z denote the three-dimensional coordinates on the pre-stored map; x_{C1} and y_{C1} denote the two-dimensional coordinates of the first camera corresponding to the three-dimensional coordinates; K₁ and D₁ denote the intrinsic parameters of the first camera; and RT₁ denotes the extrinsic parameters between the pre-stored map and the first camera.

At this time, D₁ may be calculated according to the following equation.

$$γ ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

Subsequently, the optimization unit 225 may project the point cloud data from the pre-stored map onto at least one image captured by the (n+1)-th camera (cam2, cam3, or cam4), and may estimate the image coordinates on the image captured by the (n+1)-th camera corresponding to the coordinates of the point cloud data in the pre-stored map, based on the parameters (RT1) obtained in the process of estimating the coordinates on the image captured by the first camera (cam1).

In other words, the optimization unit 225 may estimate the image coordinates on at least one image captured by the (n+1)-th camera (cam2, cam3, or cam4), corresponding to the coordinates of the point cloud data in the pre-stored map, with reference to the first camera (cam1).

That is, the optimization unit 225 may estimate the image coordinates on at least one image captured by the (n+1)-th camera, corresponding to the coordinates of the point cloud data in the pre-stored map, using the following equation.

$$[ \begin{matrix}{x}_{Cn + 1} \\ {y}_{Cn + 1}\end{matrix} ] = [ {K}_{n + 1} ] [ {D}_{n + 1} ] [ {RT}_{n + 1} ] [ {RT}_{1} ] * [ \begin{matrix}X \\ Y \\ Z \\ 1\end{matrix} ] \qquad [ Equation ]$$

Here, X, Y, and Z denote the three-dimensional coordinates on the pre-stored map; x_{Cn+1} and y_{Cn+1} denote the two-dimensional coordinates of the (n+1)-th camera corresponding to the three-dimensional coordinates; Kₙ₊₁ and Dₙ₊₁ denote the intrinsic parameters of the (n+1)-th camera; RTₙ₊₁ denotes the extrinsic parameters between the pre-stored map and the (n+1)-th camera; and RT₁ denotes the extrinsic parameters between the pre-stored map and the first camera.

At this time, Dₙ₊₁ may be calculated according to the following equation.

$$γ ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

The optimization unit 225 may optimize the parameters among the plurality of cameras (cam1, cam2, cam3, and cam4) based on the image coordinates corresponding to the coordinates of the point cloud data in the pre-stored map captured by the first camera (cam1), and the image coordinates corresponding to the same point cloud coordinates captured by at least one of the (n+1)-th cameras (cam2, cam3, and cam4).

Specifically, the optimization unit 225 may optimize the parameters among the plurality of cameras (cam1, cam2, cam3, and cam4) based on the error between the estimated image coordinates and the corresponding preset target coordinates on the image.

That is, the optimization unit 225 may optimize the parameters among the plurality of cameras (cam1, cam2, cam3, and cam4) using an error function defined by the following equation.

$${f}^{n} = [ \begin{matrix}{x}_{dest}^{n} - {x}_{Cx}^{n} \\ {y}_{dest}^{n} - {y}_{Cx}^{n}\end{matrix} ] \qquad [ Equation ]$$

Here,

$${x}_{dest}^{n} and {y}_{dest}^{n}$$

denote the target coordinates, and

$${x}_{Cx}^{n} and {y}_{Cx}^{n}$$

denote the estimated image coordinates corresponding to the target coordinates.

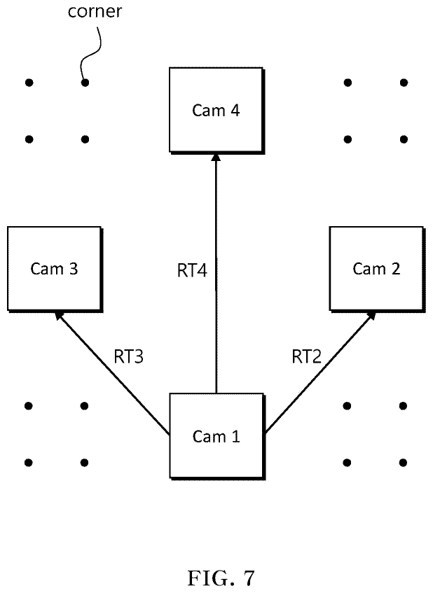

In another embodiment, the optimization unit 225 may optimize the parameters among a plurality of cameras by utilizing the fact that the cameras are fixed relative to one another and by using images captured in different poses of the integrated camera set. This embodiment of the optimization unit will be described with reference to FIGS. 6 and 7.

FIG. 7 is an example diagram illustrating a parameter optimization process according to another embodiment of the present disclosure.

Referring to FIGS. 6 and 7, the optimization unit 225 may receive a plurality of images captured in a first pose and a plurality of images captured in a second pose from the plurality of cameras (cam1, cam2, cam3, and cam4). For example, as shown in FIG. 6, images are captured in the first pose, and as shown in FIG. 7, images are captured in a second pose where the camera assembly is rotated 180 degrees.

Then, the optimization unit 225 may project the point cloud data from the pre-stored map onto the images captured in the first pose to estimate a first set of parameters among the cameras. Specifically, the optimization unit 225 may estimate the parameters between the pre-stored map and the first camera (cam1) by projecting the point cloud data onto the image captured by cam1 in the first pose. Based on those parameters, it may then project the point cloud data onto at least one image captured by the (n+1)-th camera (cam2, cam3, or cam4) to estimate the parameters between the pre-stored map and each (n+1)-th camera.

Since the process of estimating the first set of parameters is the same as that previously described in relation to FIGS. 5 and 6, detailed explanation is omitted here.

Next, the optimization unit 225 may estimate a second set of parameters based on the images captured in the second pose. That is, the optimization unit 225 may perform the same process described above using the second set of images to estimate the parameters between the pre-stored map and each camera in the second pose.

Then, the optimization unit 225 may estimate image coordinates that minimize the error between the first and second sets of parameters. Since the relative positions of the cameras are fixed, the parameters between the cameras should remain the same regardless of pose changes. Based on this principle, the optimization unit 225 may estimate image coordinates that minimize parameter error by projecting the point cloud data onto images captured in multiple poses.

Using these estimated image coordinates, the optimization unit 225 may optimize the parameters among the plurality of cameras (cam1, cam2, cam3, and cam4) based on the image coordinates from cam1 and from at least one of cam2, cam3, and cam4 corresponding to the point cloud data.

Specifically, the optimization unit 225 may optimize the parameters among the cameras based on the error between the image coordinates (obtained under pose variation that minimizes error) and the corresponding predefined target coordinates.

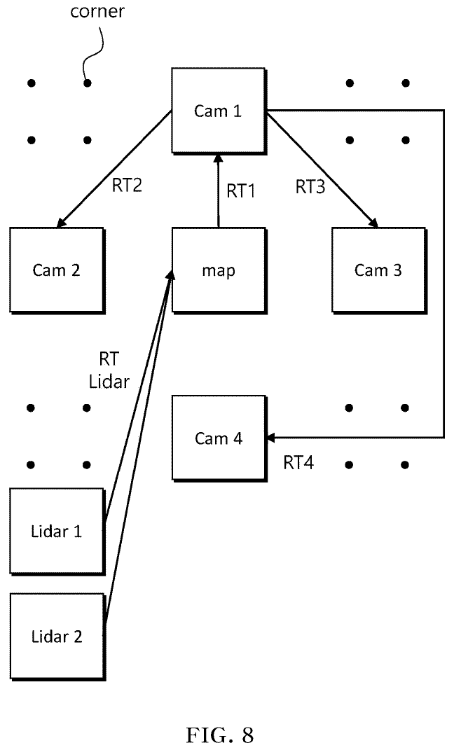

In another embodiment, the optimization unit 225 may optimize the parameters among multiple cameras using the coordinates of point cloud data acquired from a LiDAR. This embodiment will be described with reference to FIG. 8.

FIG. 8 is an example diagram illustrating a parameter optimization process according to another embodiment of the present disclosure.

Referring to FIG. 8, the optimization unit 225 may receive a plurality of images captured by the cameras (cam1, cam2, cam3, and cam4) and first point cloud data acquired by LiDAR sensors (LiDAR1, LiDAR2), simultaneously with the images.

First, the optimization unit 225 may map the first point cloud data to second point cloud data included in the pre-stored map and estimate the parameters between the LiDAR and the map.

Then, the optimization unit 225 may project at least one of the first and second point cloud data onto the images and estimate the image coordinates corresponding to the point cloud coordinates based on the estimated parameters.

Here, the optimization unit 225 may estimate the coordinates on the images captured by the cameras (cam1 to cam4) based on at least one corner point of the calibration board included in the point cloud data.

Specifically, the optimization unit 225 may project the second point cloud data onto an image captured by the first camera (cam1) and estimate the coordinates on that image corresponding to the second point cloud data.

That is, the optimization unit 225 may estimate the image coordinates on the image captured by the first camera (cam1), corresponding to the coordinates of the first point cloud data, using the following equation.

$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation ]$$

Here, X, Y, and Z denote the three-dimensional coordinates of the second point cloud data; x_{C1} and y_{C1} denote the two-dimensional coordinates of the first camera corresponding to the three-dimensional coordinates of the second point cloud data; K₁ and D₁ denote the intrinsic parameters of the first camera; and RT₁ denotes the extrinsic parameters between the pre-stored map and the first camera.

At this time, D₁ may be calculated according to the following equation.

$$γ ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

Subsequently, the optimization unit 225 may project the second point cloud data onto at least one image captured by the (n+1)-th camera (cam2, cam3, or cam4), and may estimate the image coordinates corresponding to the coordinates of the first point cloud data based on the parameters obtained during the process of estimating the coordinates on the image captured by the first camera (cam1) and the parameters between the pre-stored map and the LiDARs (LiDAR1, LiDAR2).

In other words, the optimization unit 225 may estimate the image coordinates on at least one image captured by the (n+1)-th camera (cam2, cam3, or cam4), corresponding to the coordinates of the first point cloud data, using the following equation.

$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{LiDAR} ] * [ \begin{matrix}X \\ Y \\ Z \\ 1\end{matrix} ] \qquad [ Equation ]$$

Here, X, Y, and Z denote the three-dimensional coordinates of the first point cloud data; x_{Cn+1} and y_{Cn+1} denote the two-dimensional coordinates of the (n+1)-th camera corresponding to the three-dimensional coordinates of the first point cloud data; Kₙ₊₁ and Dₙ₊₁ denote the intrinsic parameters of the (n+1)-th camera; RTₙ₊₁ denotes the extrinsic parameters between the LiDAR and the (n+1)-th camera; and RT₁ denotes the extrinsic parameters between the pre-stored map and the first camera.

At this time, Dₙ₊₁ may be calculated according to the following equation.

$$γ ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

In addition, the optimization unit 225 may optimize the parameters among the plurality of cameras (cam1, cam2, cam3, and cam4) based on the image coordinates corresponding to the coordinates of the second point cloud data captured by the first camera (cam1), and the image coordinates corresponding to the same point cloud coordinates captured by at least one of the (n+1)-th cameras (cam2, cam3, and cam4).

Specifically, the optimization unit 225 may optimize the parameters among the plurality of cameras (cam1, cam2, cam3, and cam4) based on the error between the estimated image coordinates and the corresponding predefined target coordinates on the image.

In other words, the optimization unit 225 may optimize the parameters among the plurality of cameras (cam1, cam2, cam3, and cam4) using an error function defined by the following equation.

$${f}^{n} = [ \begin{matrix}{x}_{dest}^{n} - {x}_{Cx}^{n} \\ {y}_{dest}^{n} - {y}_{Cx}^{n}\end{matrix} ] \qquad [ Equation ]$$

Here,

$${x}_{dest}^{n} and {y}_{dest}^{n}$$

denote the target coordinates, and

$${x}_{Cx}^{n} and {y}_{Cx}^{n}$$

denote the estimated image coordinates corresponding to the target coordinates.

In another embodiment, the optimization unit 225 may project the second point cloud data from the pre-stored map onto an image captured by the first camera (cam1), and estimate a first coordinate on the image captured by the first camera (cam1) corresponding to the coordinates of the second point cloud data. That is, the optimization unit 225 may estimate the image coordinates on the image captured by the first camera (cam1) corresponding to the coordinates of the second point cloud data using the following equation.

$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation ]$$

Here, X, Y, and Z denote the three-dimensional coordinates of the second point cloud data; x_{C1} and y_{C1} denote the two-dimensional coordinates of the first camera corresponding to the three-dimensional coordinates of the second point cloud data; K₁ and D₁ denote the intrinsic parameters of the first camera; and RT₁ denotes the extrinsic parameters between the pre-stored map and the first camera.

At this time, D₁ may be calculated according to the following equation:

$$γ ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

Subsequently, the optimization unit 225 may project the second point cloud data onto at least one image captured by the (n+1)-th camera (cam2, cam3, or cam4), and may estimate a second coordinate on the image captured by the (n+1)-th camera corresponding to the coordinates of the second point cloud data, based on the parameters obtained during the process of estimating the coordinates on the image captured by the first camera (cam1).

That is, the optimization unit 225 may estimate the second coordinate based on the following equation.

$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] * [ \begin{matrix}X \\ Y \\ Z \\ 1\end{matrix} ] \qquad [ Equation ]$$

Here, X, Y, and Z denote the three-dimensional coordinates of the second point cloud data; x_{Cn+1} and y_{Cn+1} denote the two-dimensional coordinates of the (n+1)-th camera corresponding to the three-dimensional coordinates of the second point cloud data; Kₙ₊₁ and Dₙ₊₁ denote the intrinsic parameters of the (n+1)-th camera; RTₙ₊₁ denotes the extrinsic parameters between the pre-stored map and the (n+1)-th camera; and RT₁ denotes the extrinsic parameters between the pre-stored map and the first camera.

At this time, Dₙ₊₁ may be calculated according to the following equation.

$$r ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

Subsequently, the optimization unit 225 may project at least one image captured by the (n+1)-th camera (cam2, cam3, or cam4) onto the pre-stored map, and may estimate a third coordinate on the image corresponding to the coordinates of the second point cloud data. This estimation is based on the parameters obtained during the process of estimating the coordinates on the image captured by the first camera (cam1), as well as the parameters between the pre-stored map and the LiDARs (LiDAR1, LiDAR2).

That is, the optimization unit 225 may estimate the third coordinate based on the following equation.

$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] [ {RT}_{LiDAR} ] * [ \begin{matrix}X \\ Y \\ Z \\ 1\end{matrix} ] \qquad [ Equation ]$$

Here, X, Y, and Z denote the three-dimensional coordinates of the second point cloud data; x_{Cn+1} and y_{Cn+1} denote the two-dimensional coordinates of the (n+1)-th camera corresponding to the three-dimensional coordinates of the second point cloud data; Kₙ₊₁ and Dₙ₊₁ denote the intrinsic parameters of the (n+1)-th camera; RTₙ₊₁ denotes the extrinsic parameters between the pre-stored map and the (n+1)-th camera; RT₁ denotes the extrinsic parameters between the pre-stored map and the first camera; and RTLiDAR denotes the parameters between the pre-stored map and the LiDAR.

At this time, Dₙ₊₁ may be calculated according to the following equation.

$$r ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the parameter search process, with respect to the optical axis.

The optimization unit 225 may optimize the parameters among the plurality of cameras based on the error between the estimated image coordinates and the corresponding predefined target coordinates on the image.

Specifically, the optimization unit 225 may optimize the parameters among the cameras (cam1, cam2, cam3, and cam4) using the first coordinate, second coordinate, and third coordinate described above. In other words, the optimization unit 225 may optimize the parameters between the LiDAR and the pre-stored map, between the pre-stored map and the first camera (cam1), and between the first camera (cam1) and the (n)-th cameras (cam2, cam3, and cam4), based on the error function between the estimated image coordinates and the corresponding predefined target coordinates.

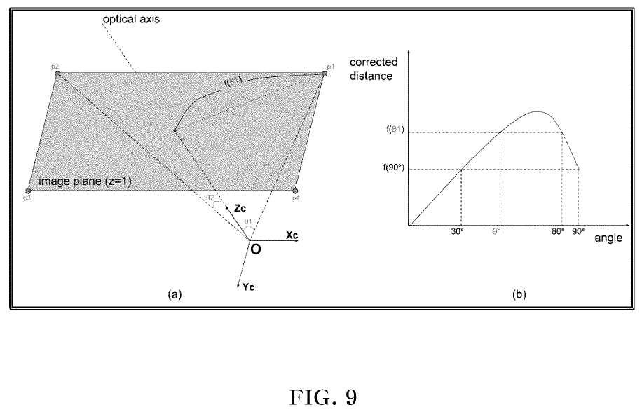

In another embodiment, the optimization unit 225 may optimize the parameters while considering image distortion. An embodiment of the optimization unit 225 related to this will be described with reference to FIG. 9.

FIG. 9 is an example diagram illustrating the process of optimizing parameters according to another embodiment of the present disclosure.

Radial distortion is caused by differences in refractive indices between the center and outer regions of the lens and is characterized by the degree of distortion increasing with distance from the center. As a result, when three-dimensional points are projected onto an image, those located in the outer regions of the image may appear to be pulled inward, creating projection errors.

To address this, the optimization unit 225 may optimize parameters in a manner that minimizes the error caused by radial distortion in the image.

Specifically, the optimization unit 225 may obtain optimized second parameters by optimizing the first parameters based on a distortion function defined by the following equation. In this case, the image may be one captured by a pinhole camera.

$$r ( x ) = {k}_{2} * {x}^{2} + {k}_{1} * x + 1 \qquad [ Equation ]$$

Here, k₂ and k₁ denote distortion coefficients, and x may represent the distance between an arbitrary three-dimensional point projected onto the image and the optical axis during the process of searching for the second parameter.

Here, the optimization unit 225 may determine that a three-dimensional point is undistorted if the distortion function is less than 0, or if k₂ is 0 and k₁ is greater than or equal to 0. Conversely, the optimization unit 225 may determine that a three-dimensional point is distorted if k₂ is 0 and k₁ is less than 0.

In this case, the optimization unit 225 may amplify the error rate of the three-dimensional point determined to be distorted—where k₂ is 0 and k₁ is less than 0 based on the following equation.

$$error = amp * - 1 * {k}_{1} \qquad [ Equation ]$$

In addition, the optimization unit 225 may calculate two roots from the distortion function. If both roots calculated according to the following equation are greater than 0, the optimization unit 225 may determine the corresponding three-dimensional point to be distorted, and may amplify the error rate of the distorted three-dimensional point and add it to the total error.

$$error 1 = amp * roof 1 ( if root 1 > 0 ) \\ error 2 = amp * roof 2 ( if root 2 > 0 ) \\ error = error 1 + error 2 \qquad [ Equation ]$$

That is, the optimization unit 225 may amplify the error rate for the three-dimensional points determined to be distorted, thereby increasing the likelihood of excluding even slightly distorted points during the process of searching for the second parameter. As a result, the accuracy of parameter optimization may be improved.

Additionally, the optimization unit 225 may optimize the first parameter based on a distortion function defined by the following equation to obtain the second parameter. In this case, the image may be one captured by a fisheye lens camera.

$$r ( x ) = {k}_{4} * {x}^{9} + {k}_{3} * {x}^{7} + {k}_{2} * {x}^{5} + {k}_{1} * {x}^{3} + x \qquad [ Equation ]$$

Here, k₄, k₃, k₂, and k₁ denote distortion coefficients, and x may represent an incident angle of an arbitrary three-dimensional point projected onto the image during the process of searching for the second parameter, with respect to the optical axis.

At this time, the optimization unit 225 may estimate the corrected distance between the optical axis and the three-dimensional points of the target point cloud data projected onto each corner of the image, and may determine a three-dimensional point to be distorted if the derivative value of the distortion function is negative and the point lies within the corrected distance.

For example, as illustrated in FIG. 9(a), the optimization unit 225 may estimate a corrected distance f(θ1) between the optical axis and a three-dimensional point (p1) of the target point cloud data projected onto each corner of the image. Then, as illustrated in FIG. 9(b), the optimization unit 225 may determine that a three-dimensional point is distorted if the derivative of the distortion function is negative and the point lies within a region bounded by the corrected distance f(θ1), for example in the range of 80° to 90°.

Additionally, the optimization unit 225 may calculate the sum of the errors of individual points for both the first parameter obtained from the calibration unit 220 and the second parameter obtained according to the various embodiments described above.

That is, the optimization unit 225 may calculate a first error between the first point cloud data (obtained based on the first parameter) and the target point cloud data, and a second error between the second point cloud data (obtained based on the second parameter) and the target point cloud data.

In this case, when calculating the first and second errors, the optimization unit 225 may exclude three-dimensional points that are projected outside the image area from the first and second point cloud data.

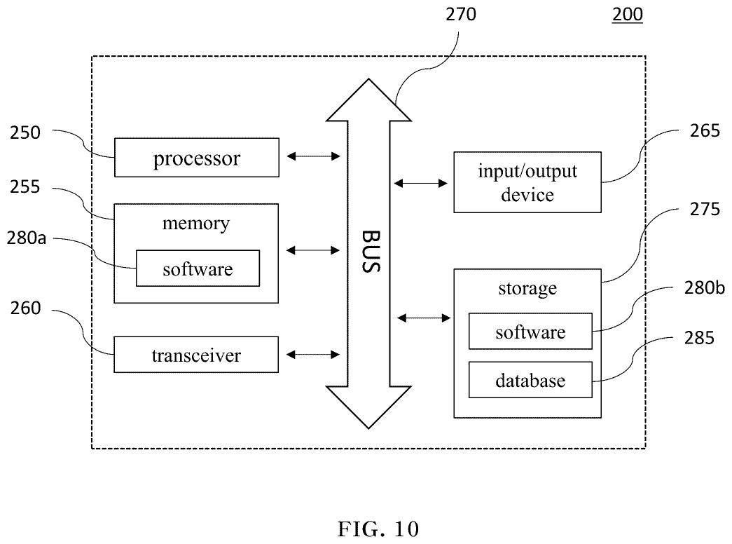

FIG. 10 illustrates a hardware configuration of a map generation device according to one embodiment of the present disclosure.

Referring to FIG. 10, the map generation device 200 may include a processor 250, memory 255, transceiver 260, input/output device 265, data bus 270, and storage 275.

The processor 250 may execute instructions stored in the memory 255, based on software 280a, to implement the operations and functions of the map generation device 200. The software 280a implementing the method according to the present disclosure may reside in the memory 255. The transceiver 260 may transmit and receive data with the data acquisition device 100 and the map application device 300.

The input/output device 265 may receive data necessary for the operation of the map generation device 200 and may output generated results. The data bus 270 may serve as a communication path for data exchange among the processor 250, memory 255, transceiver 260, input/output device 265, and storage 275.

The storage 275 may store APIs, library files, and resource files required to execute the software 280a implementing the method according to the present disclosure. The storage 275 may also store software 280b implementing the method according to the present disclosure and may store information required to perform the calibration and mapping methods. In particular, the storage 275 may include a database 285 that stores programs used to perform the calibration and map generation methods.

According to one embodiment of the present disclosure, the software 280a or 280b residing in the memory 255 or stored in the storage 275 may be a computer program recorded on a computer-readable recording medium for execution by the processor 250. The processor may: receive multiple images captured by a plurality of cameras that are fixedly installed; project point cloud data included in a pre-stored map onto the multiple images to estimate image coordinates corresponding to the coordinates of the point cloud data; and optimize parameters between the plurality of cameras based on the error between the estimated image coordinates and predefined target coordinates on the image.

According to another embodiment, the software 280a or 280b may enable the processor 250 to: receive multiple images captured by a plurality of fixedly installed cameras and point cloud data simultaneously obtained from a LiDAR; map the point cloud data to point cloud data included in a pre-stored map to estimate parameters between the pre-stored map and the LiDAR; project at least one of the point cloud datasets onto the images to estimate image coordinates corresponding to the coordinates of the point cloud data based on the estimated parameters; and optimize parameters between the cameras based on the error between the estimated and target image coordinates.

According to yet another embodiment, the software 280a or 280b may enable the processor 250 to: project LiDAR-obtained point cloud data onto an image captured by a camera to acquire a first parameter; optimize the first parameter to acquire a second parameter; compute a first error between point cloud data acquired based on the first parameter and the target point cloud data, and a second error between point cloud data acquired based on the second parameter and the target point cloud data; and determine the second parameter as the optimized parameter if the first error is greater than the second error.

More specifically, the processor 250 may include an ASIC (Application-Specific Integrated Circuit), other chipsets, logic circuits, and/or data processing units. The memory 255 may include ROM, RAM, flash memory, memory cards, and other storage devices. The transceiver 260 may include a baseband circuit for processing wired/wireless signals. The input/output device 265 may include input devices such as a keyboard, mouse, or joystick, and output devices such as an LCD, OLED, AMOLED, printer, or plotter.

If implemented in software, the methods described herein may be realized as modules (procedures or functions) performing the described functionalities. The modules may reside in the memory 255 and may be executed by the processor 250. The memory 255 may be internal or external to the processor and may be connected by known means.

Each component shown in FIG. 10 may be implemented by various means including hardware, firmware, software, or combinations thereof. In the case of hardware implementation, the embodiment may be realized using one or more ASICs, DSPs, DSPDs, PLDs, FPGAS, processors, controllers, microcontrollers, or microprocessors.

In the case of firmware or software implementation, the embodiment may be realized as a module, procedure, or function performing the above-described functions and operations and may be recorded on a computer-readable recording medium via various computing devices. Such a medium may include program instructions, data files, data structures, and may be implemented using magnetic media (e.g., hard disks, floppy disks, magnetic tapes), optical media (e.g., CD-ROMs, DVDs), magneto-optical media, and hardware specially configured to store and execute program instructions (e.g., ROM, RAM, flash memory). Examples of program instructions may include machine code generated by compilers and high-level language code executable by computers using interpreters, etc. These hardware components may be configured to operate with one or more software modules, and vice versa.

Hereinafter, the operation of the map generation device 200 described above will be explained in more detail.

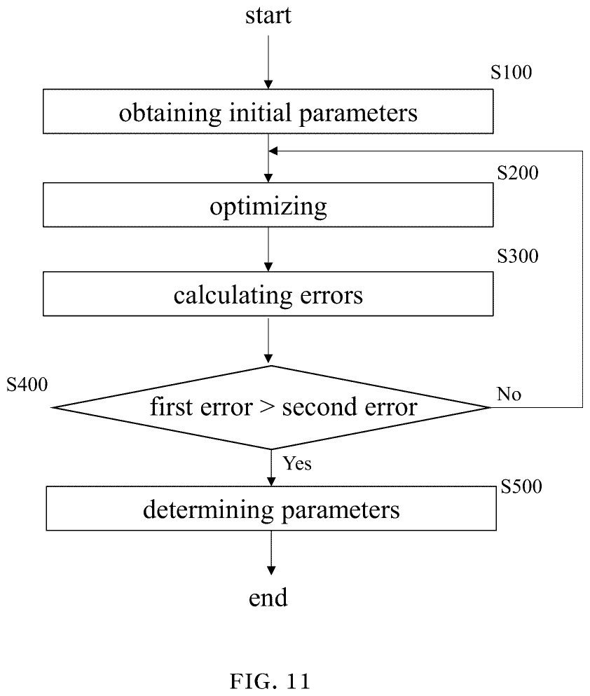

FIG. 11 is a flowchart illustrating a method for optimizing parameters between a LiDAR and a camera in consideration of image distortion, according to an embodiment of the present invention.

As shown in FIG. 11, the map generation device 200 may project first point cloud data acquired from the LiDAR onto an image captured by the camera to obtain a first parameter (S100). That is, the map generation device 200 may obtain an initial parameter through calibration by projecting the first point cloud data acquired from the LiDAR onto the image captured by the camera.

Next, the map generation device 200 may optimize the obtained first parameter to obtain a second parameter (S200). At this time, the map generation device 200 may take image distortion into account. Here, the map generation device 200 may search for the second parameter that minimizes the error from the first parameter based on an algorithm related to non-linear least squares. For example, the map generation device 200 may search for the second parameter by using at least one of the Gauss-Newton method, the Gradient Descent method, and the Levenberg-Marquardt method.

Next, the map generation device 200 may calculate a first error between the first point cloud data obtained based on the first parameter and target point cloud data, and a second error between the second point cloud data obtained based on the second parameter and the target point cloud data (S300). Here, the error may be the sum of the errors between the three-dimensional points included in the first or second point cloud data and the three-dimensional points included in the target point cloud data.

Then, in step S400, if the first error is greater than the second error, the map generation device 200 may determine the second parameter as the optimized parameter (S500). Conversely, if the first error is smaller than the second error, optimization (S200) may be performed again.

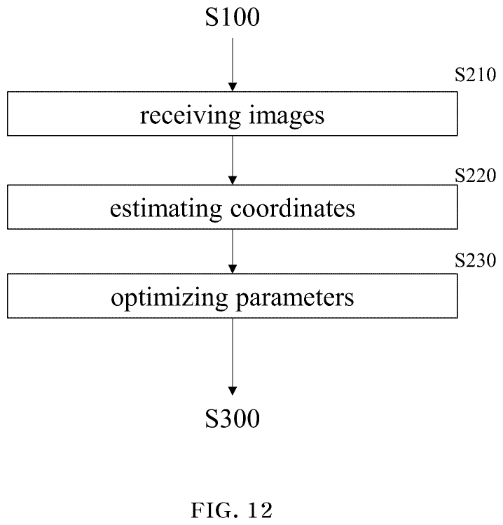

FIG. 12 is a flowchart illustrating a method for optimizing parameters between multiple cameras using a pre-generated map, according to an embodiment of the present invention.

As shown in FIG. 12, the map generation device 200 may receive a plurality of images captured by a plurality of cameras that are fixedly installed relative to each other (S210).

Next, the map generation device 200 may project point cloud data included in the pre-generated map onto the plurality of images to estimate image coordinates corresponding to the coordinates of the point cloud data included in the pre-generated map (S220).

Then, the map generation device 200 may optimize parameters between the plurality of cameras based on the error between the estimated image coordinates and the predetermined target coordinates on the images corresponding to the estimated image coordinates (S230).

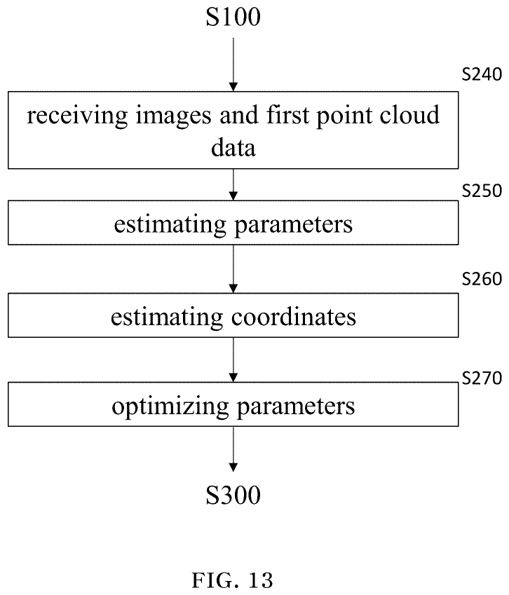

FIG. 13 is a flowchart illustrating a method for optimizing parameters between multiple cameras using LiDAR, according to an embodiment of the present invention.

As shown in FIG. 13, the map generation device 200 may receive a plurality of images captured by a plurality of cameras and, simultaneously, first point cloud data obtained from LiDAR (S240).

Next, the map generation device 200 may map the first point cloud data to second point cloud data included in a pre-generated map, and estimate parameters between the pre-generated map and the LiDAR (S250).

Then, the map generation device 200 may project at least one of the first point cloud data and the second point cloud data onto the plurality of images, and estimate image coordinates corresponding to the coordinates of at least one of the first and second point cloud data based on the estimated parameters (S260).

Subsequently, the map generation device 200 may optimize parameters between the plurality of cameras based on the error between the estimated image coordinates and the predetermined target coordinates corresponding to the estimated image coordinates (S270).

As described above, the present specification and drawings disclose preferred embodiments of the present invention. However, it will be apparent to those skilled in the art that various modifications based on the technical spirit of the present invention are also possible in addition to the embodiments disclosed herein.

Furthermore, although specific terms are used in the present specification and drawings, they are employed only for the purpose of easily explaining the technical content of the invention and enhancing understanding of the invention, and are not intended to limit the scope of the invention.

Accordingly, the above detailed description should not be construed as being limiting in all respects, but rather as being illustrative. The scope of the present invention should be defined by the reasonable interpretation of the appended claims, and all modifications within the equivalent scope of the present invention are to be included within the scope of the invention.

What is claimed is:

1. An optimizing method, the optimizing method comprising:
receiving images captured from a plurality of cameras and first point cloud data acquired, simultaneously with the images, from a LiDAR;
estimating parameters between a pre-stored map and the LiDAR by mapping the first point cloud data to second point cloud data included in the pre-stored map;
estimating image coordinates corresponding to coordinates of at least one of the first point cloud data or the second point cloud data based on the estimated parameters by projecting at least one of the first point cloud data or the second point cloud data onto the images; and
optimizing parameters among the plurality of cameras based on errors between the estimated image coordinates and target coordinates in the image corresponding to the estimated image coordinates,
wherein the receiving comprises:
receiving a plurality of images captured in a first pose and a plurality of images captured in a second pose from the plurality of cameras;
wherein the estimating image coordinates comprises:
estimating first parameters among the plurality of cameras by projecting the point cloud data included in the pre-stored map onto the plurality of images captured in the first pose;
estimating second parameters among the plurality of cameras based on the plurality of images captured in the second pose; and
estimating image coordinates corresponding to the coordinates of the point cloud data included in the pre-stored map based on the first parameters and the second parameters.

2. The optimizing method of claim 1,
wherein the first point cloud data and the second point cloud data include point cloud data acquired from a calibration board, and
wherein the plurality of cameras captures at least a part of the calibration board.

3. The optimizing method of claim 2, wherein the estimating the coordinates comprises:
estimating the image coordinates captured by the plurality of cameras corresponding to at least one corner point of the calibration board,
wherein the calibration board is included in at least one of the first point cloud data or the second point cloud data.

4. The optimizing method of claim 1, wherein the estimating the coordinates comprises:
estimating the image coordinates corresponding to the coordinates of the second point cloud data in an image captured by a first camera by projecting the second point cloud data onto the image captured by the first camera; and
estimating image coordinates corresponding to the coordinates of the first point cloud data in at least one image captured by a (n+1)th camera based on parameters obtained from the process of estimating the image coordinates in the image captured by the first camera and parameters between the pre-stored map and the LiDAR by projecting the second point cloud data onto the at least one image captured by the (n+1)th camera.

5. The optimizing method of claim 4, wherein the estimating the image coordinates in the image captured by the first camera comprises:
estimating the image coordinates corresponding to the coordinates of the first point cloud data in the image captured by the first camera based on [Equation 1],
$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation 1 ]$$
wherein X, Y, and Z denote three-dimensional coordinates of the second point cloud data,
wherein x_{C1} and y_{C1} denote two-dimensional coordinates of the first camera corresponding to the three-dimensional coordinates of the second point cloud data,
wherein K₁ and D₁ denote intrinsic parameters of the first camera,
wherein RT₁ denotes extrinsic parameters between the pre-stored map and the first camera,
wherein D₁ is calculated based on Equation 2,
$$r ( x ) = {k}_{4} * {x}^{9} + {k}_{3} * {x}^{7} + {k}_{2} * {x}^{5} + {k}_{1} * {x}^{3} + x \qquad [ Equation 2 ]$$
wherein k₄, k₃, k₂, and k₁ denote distortion coefficients,
wherein x denotes an incident angle at which an arbitrary three-dimensional point projected onto an image enters with respect to an optical axis during a process of searching for parameters.

6. The optimizing method of claim 1, wherein the estimating coordinates comprises:
estimating first coordinates on the image captured by the first camera corresponding to the coordinates of the second point cloud data by projecting the second point cloud data onto the image captured by the first camera;
estimating second coordinates on the at least one image captured by the (n+1)th camera corresponding to the coordinates of the second point cloud data, based on parameters obtained from the process of estimating the coordinates on the image captured by the first camera, by projecting the second point cloud data onto at least one image captured by the (n+1)th camera; and
estimating third coordinates on the at least one image captured by the (n+1)th camera corresponding to the coordinates of the second point cloud data, based on the parameters obtained from the process of estimating the coordinates on the image captured by the first camera and a parameter between the pre-stored map and the LiDAR, by projecting the at least one image captured by the (n+1)th camera onto the pre-stored map.

7. The optimizing method of claim 6, wherein estimating the first coordinates comprises:
estimating the coordinates on the image captured by the first camera corresponding to the coordinates of the second point cloud data based on [Equation 3],
$$[ \begin{matrix}{x}_{C 1} \\ {y}_{C 1}\end{matrix} ] = [ {K}_{1} ] [ {D}_{1} ] [ {RT}_{1} ] * [ \begin{matrix}X \\ Y \\ Z \\ 1\end{matrix} ] \qquad [ Equation 3 ]$$
wherein X, Y, and Z denote the three-dimensional coordinates of the second point cloud data,
wherein x_{C1} and y_{C1} denote two-dimensional coordinates on the image captured by the first camera corresponding to the three-dimensional coordinates of the second point cloud data,
wherein K₁ and D₁ denote the intrinsic parameters of the first camera, and
wherein RT₁ denotes the extrinsic parameters between the pre-stored map and the first camera,
wherein D₁ is calculated based on [Equation 4],
$$r ( x ) = {k}_{4} * {x}^{9} + {k}_{3} * {x}^{7} + {k}_{2} * {x}^{5} + {k}_{1} * {x}^{3} + x \qquad [ Equation 4 ]$$
wherein k₄, k₃, k₂, and k₁ denote distortion coefficients,
wherein x denotes the incident angle at which the arbitrary three-dimensional point projected onto the image enters with respect to the optical axis during the process of searching for parameters.

8. The optimizing method of claim 7, wherein estimating the second coordinates comprises:
estimating the second coordinates based on [Equation 5],
$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] * [ \begin{matrix}X \\ Y \\ Z \\ 1\end{matrix} ] \qquad [ Equation 5 ]$$
wherein X, Y, and Z denote the three-dimensional coordinates of the second point cloud data;
wherein x_{Cn+1} and y_{Cn+1} denote two-dimensional coordinates of the (n+1)th camera corresponding to the three-dimensional coordinates of the second point cloud data;
wherein Kₙ₊₁ and Dₙ₊₁ denote intrinsic parameters of the (n+1)th camera;
wherein RTₙ₊₁ denotes extrinsic parameters between the pre-stored map and the (n+1)th camera;
wherein RT₁ denotes the extrinsic parameters between the pre-stored map and the first camera,
wherein Dₙ₊₁ is calculated based on [Equation 6]
$$r ( x ) = {k}_{4} * {x}^{9} + {k}_{3} * {x}^{7} + {k}_{2} * {x}^{5} + {k}_{1} * {x}^{3} + x \qquad [ Equation 6 ]$$
wherein k₄, k₃, k₂, and k₁ denote distortion coefficients,
wherein x denotes the incident angle at which the arbitrary three-dimensional point projected onto the image enters with respect to the optical axis during the process of searching for parameters.

9. The optimizing method of claim 8, wherein estimating the third coordinates comprises:
estimating the third coordinates based on Equation 7,
$$[ \begin{matrix}{x}_{cn + 1} \\ {y}_{cn + 1}\end{matrix} ] = [ {K}_{n + 1} ] [ {D}_{n + 1} ] [ {RT}_{n + 1} ] [ {RT}_{1} ] [ {RT}_{LiDAR} ] * [ \begin{matrix}X \\ Y \\ Z \\ 1\end{matrix} ] \qquad [ Equation 7 ]$$
wherein X, Y, and Z denote the three-dimensional coordinates of the second point cloud data,
wherein x_{Cn+1} and y_{Cn+1} denote the two-dimensional coordinates of the (n+1)th camera corresponding to the three-dimensional coordinates of the second point cloud data,
wherein Kₙ₊₁ and Dₙ₊₁ denote the intrinsic parameters of the (n+1)th camera,
wherein RTₙ₊₁ denotes the extrinsic parameters between the pre-stored map and the (n+1)th camera,
wherein RT₁ denotes the extrinsic parameters between the pre-stored map and the first camera,
wherein RTLIDAR denotes the parameters between the pre-stored map and the LiDAR,
wherein Dₙ₊₁ is calculated based on [Equation 8],
$$r ( x ) = {k}_{4} * {x}^{9} + {k}_{3} * {x}^{7} + {k}_{2} * {x}^{5} + {k}_{1} * {x}^{3} + x \qquad [ Equation 8 ]$$
wherein k₄, k₃, k₂, and k₁ denote distortion coefficients,
wherein x denotes the incident angle at which the arbitrary three-dimensional point projected onto the image enters with respect to the optical axis during the process of searching for parameters.

10. A map generation device for optimizing, the map generation device comprising:
a memory;
a transceiver; and
a processor configured to execute instructions stored in the memory,
wherein the processor is configured to:
receive images captured from a plurality of cameras and first point cloud data acquired, simultaneously with the images, from a LiDAR;
estimate parameters between a pre-stored map and the LiDAR by mapping the first point cloud data to second point cloud data included in the pre-stored map;
estimate image coordinates corresponding to coordinates of at least one of the first point cloud data or the second point cloud data based on the estimated parameters by projecting at least one of the first point cloud data or the second point cloud data onto the images; and
optimize parameters among the plurality of cameras based on errors between the estimated image coordinates and target coordinates in the image corresponding to the estimated image coordinates,
wherein the receiving comprises:
receive a plurality of images captured in a first pose and a plurality of images captured in a second pose from the plurality of cameras;
wherein the estimating image coordinates comprises:
estimate first parameters among the plurality of cameras by projecting the point cloud data included in the pre-stored map onto the images captured in the first pose;
estimate second parameters among the plurality of cameras based on the images captured in the second pose; and
estimate image coordinates corresponding to the coordinates of the point cloud data included in the pre-stored map based on the first parameters and the second parameters.
